(19) United States
(12) Patent Application Publication
(10) Pub. No.: US 2015/0113333 A1
(43) Pub. Date: Apr. 23, 2015

(54) DATA PROCESSING SYSTEM AND OPERATING METHOD THEREOF

(71) Applicant: SK hynix Inc., Gyeonggi-do (KR)

(72) Inventor: Hyun Wook KIM, Gyeonggi-do (KR)

(73) Assignee: SK hynix Inc., Gyeonggi-do (KR)

(21) Appl. No.: 14/143,965

(22) Filed: Dec. 30, 2013

(30) Foreign Application Priority Data
Oct. 18, 2013 (KR) 10-2013-0124742

(51) Int. Cl. G06F 11/22

(52) U.S. Cl. CPC G06F 11/221
USPC 714/43

(57) ABSTRACT

An operating method of a data processing system includes calculating a test result by performing a test for measuring characteristics of each of lanes included in the data processing system, and selecting one or more operating lanes among the lanes based on the test result.

### CROSS-REFERENCES TO RELATED APPLICATION

The present application claims priority under 35 U.S.C. §119(a) to Korean application number 10-2013-0124742, filed on Oct. 18, 2013, in the Korean Intellectual Property Office, which is incorporated herein by reference in its entirety.

### BACKGROUND

1. Technical Field

Various embodiments of the present invention relate to a data processing system, and more particularly, to a signal transmission scheme of a data processing system.

2. Related Art

Recently, the paradigm for computer surroundings has changed to a ubiquitous computing environment in which computer systems may be used anytime and anywhere. Thus, the use of portable electronic devices such as mobile phones, digital cameras, and notebook computers has rapidly increased. Such portable electronic devices generally employ a data storage device using a memory device. The data storage device is used as a main memory or auxiliary memory of the portable electronic devices.

Since the data storage device using a memory device has no mechanical driver, the data storage device has excellent stability and durability. Furthermore, the data storage device may operate at high access speed and with small power consumption. The data storage device having such advantages may include a universal serial bus (USB) memory device, a memory card having various interfaces, and a solid-state drive (SSD).

The data processing system may include an electronic device that may process data such as audio data and image data. Thus, the portable electronic device may be classified as a data processing system in a broad sense. A data processing system including the portable electronic device may be implemented by combining a data storage device and various other devices. The data storage device and the various other devices may be connected through interfaces, and exchange data signals through the interfaces. Thus, signal integrity transmitted between the interfaces may be directly connected to the performance of the data processing system.

### SUMMARY

Various embodiments of the present invention are directed to a data processing system that may secure efficient signal transmission, and an operating method thereof.

In an embodiment of the present invention, an operating method of a data processing system may include calculating a test result by performing a test for measuring characteristics of each of lanes, and selecting one or more operating lanes among the lanes based on the test result.

In an embodiment of the present invention, a data processing system may include a first device including a first control unit, a second device including a second control unit, and lanes suitable for transmitting signals between the first and second devices, wherein the first and second control units calculate a test result by performing a test for measuring characteristics of the respective lanes, and select one or more operating lanes among the lanes based on the test result.

In an embodiment of the present invention, an operating method of a data processing system with multi-channels may include performing a test for measuring a predetermined characteristic of the respective channels, ranking the channels based on the test result, and performing a communication through the high-ranked channels selected among the channels.

### BRIEF DESCRIPTION OF THE DRAWINGS

Features, aspects, and embodiments are described in conjunction with the attached drawings, in which:

FIG. 1 is a block diagram illustrating a data processing system according to an embodiment of the present invention;

FIG. 2 is a block diagram illustrating a data processing system in which two-way communication is performed, according to an embodiment of the present invention;

FIG. 3 is a flowchart for explaining an operating method of the data processing system shown in FIG. 1;

FIG. 4 is a table showing a case in which one or more operating lanes are selected according to the operating method of FIG. 3;

FIG. 5 is a flowchart for explaining another operating method of the data processing system shown in FIG. 1; and

FIG. 6 is a table showing a case in which one or more operating lanes are selected according to the operating method of FIG. 5.

### DETAILED DESCRIPTION

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

The drawings are not necessarily to scale and in some instances, proportions may have been exaggerated to clearly illustrate features of the embodiments. In this specification, specific terms have been used. The terms are used to describe the present invention, and are not used to qualify the sense or limit the scope of the present invention. Throughout the disclosure, reference numerals correspond directly to the like numbered parts in the various figures and embodiments of the present invention.

In this specification, ‘and/or’ represents that one or more of components arranged before and after ‘and/or’ is included. Furthermore, ‘connected/coupled’ represents that one component is directly coupled to another component or indirectly coupled through another component. In this specification, a singular form may include a plural form as long as it is not specifically mentioned in a sentence. Furthermore, ‘include/comprise’ or ‘including/comprising’ used in the specification represents that one or more components, steps, operations, and elements exists or are added.

Hereafter, the exemplary embodiments of the present invention will be described with reference to the drawings.

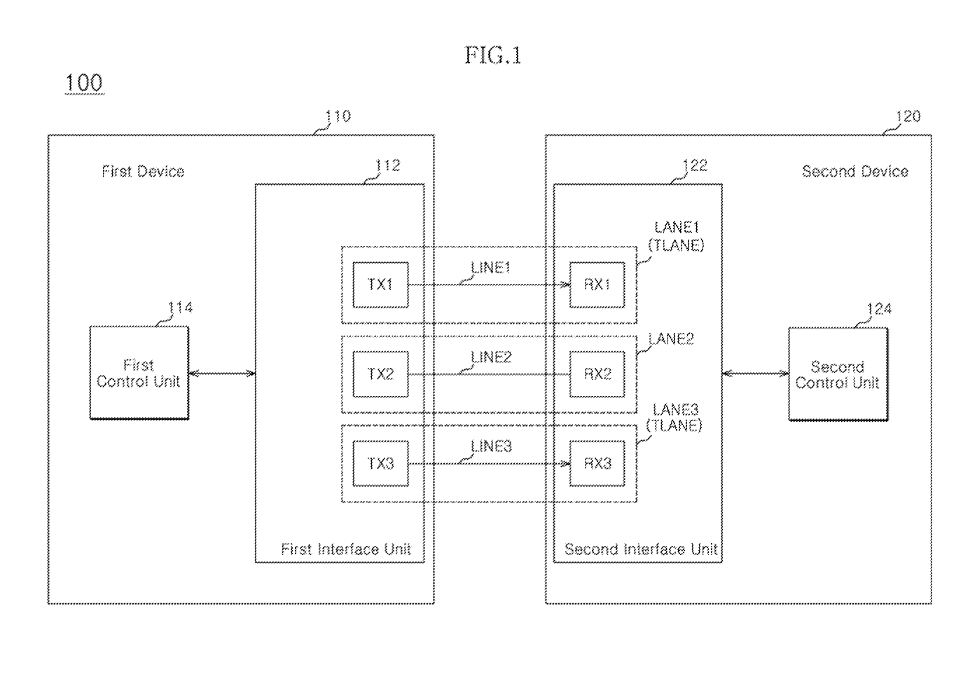

FIG. 1 is a block diagram illustrating a data processing system 100 according to an embodiment of the present invention.

The data processing system 100 may include first and second devices 110 and 120. Each of the first and second devices 110 and 120 may be a device, which is used when the data processing system 100 processes data, such as an input device, an output device, a calculation device, a storage device, or a communication device.

For example, the first device 110 may serve as a host device of the data processing system 100, and the second device 120 may serve as a data storage device of the data processing system 100. The host device includes portable electronic devices such as mobile phones and MP3 players or electronic devices such as laptop computers, desktop computers, game machines, TVs, and beam projectors. The data storage device may include a device to process data in response to a request from the host device. The data storage device may store data processed by the host device. That is, the data storage device may be used as a memory of the host device.

The first device 110 may include a first interface unit 112 and a first control unit 114. The second device 120 may include a second interface unit 122 and a second control unit 124.

The first and second interface units 112 and 122 may include standard interfaces such as a serial advanced technology attachment (SATA), a parallel advanced technology attachment (PATA), a universal serial bus (USB), a small computer system interface (SCSI), a serial attached SCSI (SAS), a peripheral component interconnect (PCI), a peripheral component interconnect-express (PCI-express), a universal flash storage (UFS), a mobile industry processor interface M-PHY (MIPI M-PHY), and/or a card interface. The first and second devices 110 and 120 may communicate with each other through the first and second interface units 112 and 122.

In the following descriptions, a lane LANE is defined to include a transmitter for transmitting a signal, a receiver for receiving a signal, and a transmission line for connecting the transmitter and the receiver for signal transmission. Further, a lane may be referred to as a channel.

A first lane LANE1 may include a first transmitter TX1 in the first interface unit 112, a first receiver RX1 in the second interface unit 122, and a first transmission line LINE1. A second lane LANE2 may include a second transmitter TX2 in the first interface unit 112, a second receiver RX2 in the second interface unit 122, and a second transmission line LINE2. A third lane LANE3 may include a third transmitter TX3 in the first interface unit 112, a third receiver RX3 in the second interface unit 122, and a third transmission line LINES.

When a plurality of lanes are provided, a data transmission rate may be increased as the number of the lanes used at the same time increases. In such case, however, power consumption may be increased and/or a transmission delay may occur due to interference between the lanes. Thus, signals may be transmitted through selected lanes among the lanes.

When a signal is to be transmitted through a part of the lanes LANE<1.3>, one or more operating lanes TLANEs may be selected according to a method to be described below. The first and second devices 110 and 120 may communicate with each other through the selected lanes (i.e., the operating lanes TLANEs). For example, FIG. 1 illustrates a case in which the first and third lanes LANE1 and LANE3 are selected as the operating lane TLANE. The first and second devices 110 and 120 may communicate with each other through the first and third lanes LANE1 and LANE3. The second lane LANE2, which is not selected as the operating lane TLANE may not transmit a signal. For convenience of description, FIG. 1 illustrates a one-way communication from the transmitters TX<1:3> of the first device 110 to the receivers RX<1:3> of the second device 120.

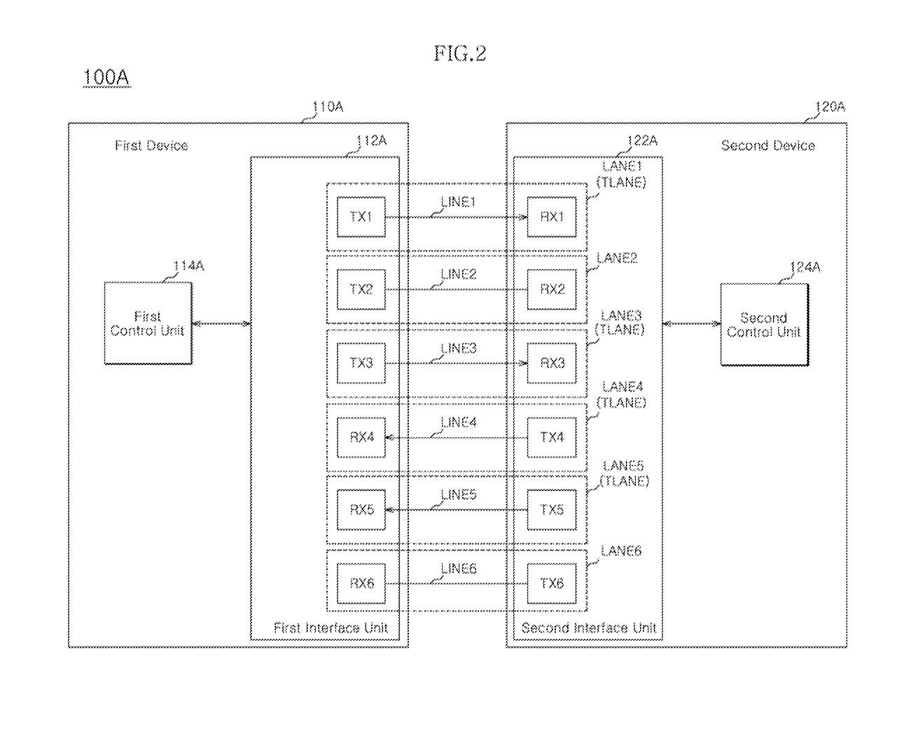

FIG. 2 is a block diagram illustrating a data processing system 100A in which two-way communication is performed, according to an embodiment of the present invention. Referring to FIG. 2, the first device 110A may further include receivers RX<4:6> as compared to the first device 110 shown in FIG. 1, and the second device 120A may further include transmitters TX<4:6> as compared to the second device 120 shown in FIG. 1. Thus, two-way communication may be performed between the first and second devices 110A and 120A. For example, FIG. 2 illustrates a case in which the first, third, fourth, and fifth lanes LANE1, LANE3, LANE4, and LANES are selected as the operating lanes TLANEs. The first device 110A may transmit signals to the second device 120A through the first and third lanes LANE1 and LANE3. The second device 120A may transmit signals to the first device 110A through the fourth and fifth lanes LANE4 and LANES. The second and sixth lanes (i.e., non-operating lanes) LANE2 and LANE6, which are not selected as the operating lanes TLANEs, may not transmit signals.

The first device 110A may include a first interface unit 112A and a first control unit 114A. The second device 120A may include a second interface unit 122A and a second control unit 124A.

The configuration to be described below with reference to FIGS. 1 and 3 to 6 may be applied to the data processing system shown in FIGS. 2.

Referring back to FIG. 1, the first and second control units 114 and 124 may select the operating lanes TLANEs among the lanes LANE<1:3>. The first and second control units 114 and 124 may perform a test for measuring a plurality of characteristics of the respective lanes LANE<1:3> and select one or more operating lanes TLANEs among the lanes LANE<1:3> based on the test result.

For example, the first and second control units 114 and 124 may set lane rankings corresponding to the respective characteristics based on the test result. Furthermore, the first and second control units 114 and 124 may determine any one of the characteristics as a lane selection criterion, and select one or more operating lanes TLANEs based on lane rankings corresponding to the determined lane selection criterion.

Further, the first and second control units 114 and 124 may set weights to be given on each of the characteristics. Then, the first and second control units 114 and 124 may set lane rankings by applying the weights to the test result, and select one or more operating lanes TLANEs based on the lane rankings.

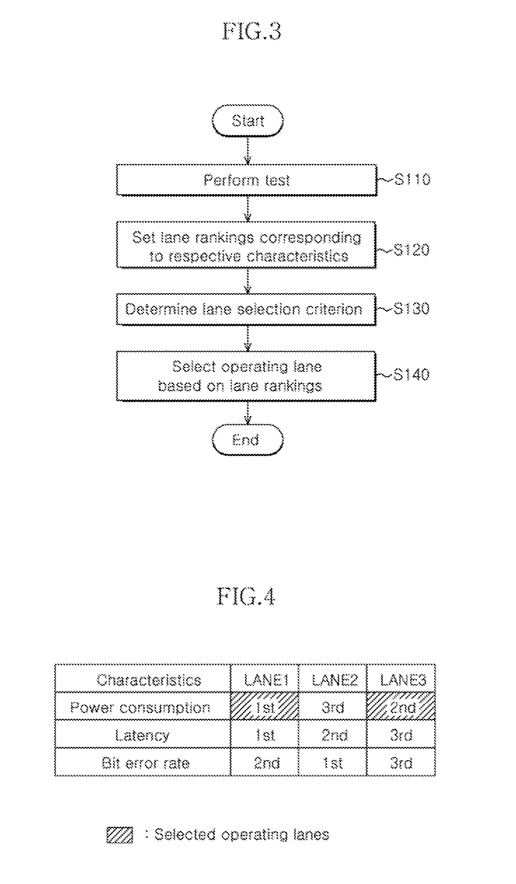

FIG. 3 is a flowchart for explaining an operating method of the data processing system of FIG. 1. FIG. 3 shows a process in which the first control unit 114 and the second control unit 124 select one or more operating lanes TLANEs among the plurality of lanes LANE<1:3>. The data processing system 100 may first perform the process of selecting one or more operating lanes TLANEs, when power is applied and operation is started.

At step S110, the first and second control units 114 and 124 may perform a test for measuring the characteristics of the respective lanes LANE<1:3>. The characteristics of the respective lanes LANE<1:3> may include, for example, power consumption, latency, and bit error rate, during signal transmission. The characteristics may be evaluated at the same time through one test. The test may be performed as test data are transmitted from the transmitters TX<1:3> to the receivers RX<1:3> of the lanes LANE<1:3> under the same condition. Then, the test result obtained by measuring the characteristics of the respective lanes LANE<1:3> may be calculated. Specifically, the test result for power consumption may be calculated by measuring power consumptions of the respective lanes LANE<1:3> while transmitting the same test data. Furthermore, the test result for latency may be calculated by measuring the time points at which test data are received by the receivers RX<1:3> after the same test data are transmitted from the respective transmitters TX<1:3> at the same time. Furthermore, the test result for bit error rate may be calculated through the following process: test data having a predetermined bit pattern between the first and second control units 114 and 124 are transmitted through the respective lanes LANE<1:3>, and the received test data are compared to the predetermined bit pattern to distinguish an error bit. The first and second devices 110 and 120 may include a register for storing the test results.

At step S120, the first and second control units 114 and 124 may set lane rankings corresponding to the respective characteristics based on the test result. The first and second control units 114 and 124 may share the test results stored in the registers. The first and second control units 114 and 124 may set the lane rankings by performing a simple arithmetic operation on the test result. The first and second control units 114 and 124 may set the rankings of the lanes LANE<1:3> for the respective characteristics.

At step S130, the first and second control units 114 and 124 may determine any one of the characteristics as the lane selection criterion. The lane selection criterion may be determined depending on the operating environment of the data processing system 100. That is, one characteristic, which coincides with the operating environment of the data processing system 100 and takes precedence over the other characteristics, may be determined as the lane selection criterion. For example, when the data processing system 100 requires low power consumption, power consumption may be determined as the lane selection criterion. Further, when the data processing system 100 requires a high signal transmission rate, latency may be determined as the lane selection criterion. Further, when the data processing system 100 requires high data reliability, bit error rate may be determined as the lane selection criterion.

At step S140, the first and second control units 114 and 124 may select one or more operating lanes TLANEs based on the lane rankings corresponding to the determined lane selection criterion. The number of the selected operating lanes TLANEs may be set depending on the operating environment of the data processing system 100.

FIG. 4 is a table showing a case in which one or more operating lanes TLANEs are selected according to the operating method of FIG. 3. Referring to FIG. 4, the lane rankings corresponding to the respective characteristics are set according to the test result, any one of the characteristics is determined as the lane selection criterion, and two operating lanes TLANEs are selected.

The characteristics of the respective lanes LANE<1:3>, measured through the test, may include power consumption, latency, and bit error rate. The lane rankings for the respective characteristics may be set based on the test result. For example, as the test result for power consumption, the lane rankings may be set in order of the first lane LANE1, the third lane LANE3, and the second lane LANE2. Further, as the test result for latency, the lane rankings may be set in order of the first lane LANE1, the second lane LANE2, and the third lane LANE3. Further, as the test result for bit error rate, the lane rankings may be set in order of the second lane LANE2, the first lane LANE1, and the third lane LANE3. When the power consumption is determined as the lane selection criterion, the first and third lanes LANE1 and LANE3 may be selected as the operating lanes TLANEs.

FIG. 5 is a flowchart for explaining another operating method of the data processing system of FIG. 1. FIG. 5 shows a process in which the first and second control units 114 and 124 select one or more operating lanes TLANEs among the lanes LANE<1:3>. For example, the data processing system 100 may first perform the process of selecting one or more operating lanes TLANEs when power is applied and operation is started.

At step S210, the first and second control units 114 and 124 may perform a test for measuring the characteristics of the respective lanes LANE<1:3>. The test may be first performed when power is applied to the data processing system and operation is started. For example, the characteristics of the respective lanes LANE<1:3> may include power consumption, latency, and bit error rate, during signal transmission. The characteristics may be evaluated at the same time through one test. As test data are transmitted from the transmitters TX<1:3> to the receivers RX<1:3> of the lanes LANE<1:3> under the same condition, the test may be performed. Then, the test results obtained by measuring the characteristics of the respective lanes LANE<1:3> may be calculated. Specifically, the test result for power consumption may be calculated by measuring power consumptions of the respective lanes LANE<1:3> while transmitting the same test data. Furthermore, the test result for latency may be calculated by measuring the time points at which test data are received by the receivers RX<1:3> when the same test data are transmitted from the respective transmitters TX<1:3> at the same time. Furthermore, the test result for bit error rate may be calculated through the following process: test data having a predetermined bit pattern between the first and second control units 114 and 124 are transmitted through the respective lanes LANE<1:3>, and the received test data are compared to the predetermined bit pattern to distinguish an error bit. The first and second devices 110 and 120 may include a register to store and refer to the test results.

At step S220, the first and second control units 114 and 124 may set weights to be given on the respective characteristics. The weights may be set depending on the operating environment of the data processing system 100. That is, a higher weight may be given on a characteristic, which coincides with the operating environment of the data processing system 100 and takes precedence over the other characteristics. For example, when the data processing system 100 requires low power consumption, a higher weight may be given on power consumption than the other characteristics. Further, when the data processing system 100 requires a high signal transmission rate, a higher weight may be given on latency than the other characteristics. Further, when the data processing system 100 requires high data reliability, a higher weight may be given on bit error rate than the other characteristics.

At step S230 the first and second control units 114 and 124 may set lane rankings by applying the weights to the test result.

At step S240, the first and second control units 114 and 124 may select one or more operating lanes TLANEs based on the lane rankings. The number of the selected operating lanes TLANEs may be set depending on the operating environment of the data processing system 100.

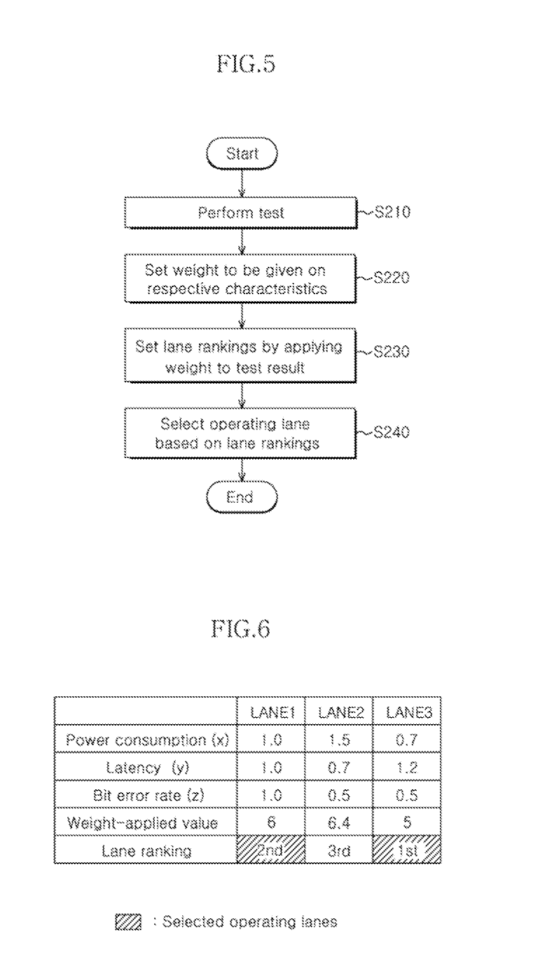

FIG. 6 is a table showing a case in which one or more operating lanes TLANEs are selected according to the operating method of FIG. 5. Referring to FIG. 6, the weights to be given on the respective characteristics are set and then applied to the test result to set lane rankings, and two operating lanes TLANEs are selected based on the lane rankings.

The characteristics of the respective lanes LANE<1:3>, measured through the test, may include power consumption, latency, and bit error rate. Referring to FIG. 6, the test results are expressed as relative values. For example, the test result for the first lane may be set to a reference value of 1.0, and the test results for the second and third lanes may be expressed as relative values. Of course, the test results may be calculated as absolute values, instead of the relative values. When a lane has low power consumption, short latency, and a small bit error rate, the lane may be considered as an excellent lane. Thus, when a test result for each lane as a relative value has a small value. It may indicate that the test result is excellent.

The weights to be given on the respective characteristics may be set depending on the operating environment of the data processing system 100. For example, when the data processing system 100 requires low power consumption, the highest weight may be added to power consumption. Furthermore, when the signal transmission rate needs to be considered rather than the data reliability, a higher weight may be added to latency than bit error rate. As a result, a weight (a) for power consumption, a weight (b) for latency, and a weight (c) for bit error rate may be set to 3, 2, and 1, respectively, (a=1, b=2, and c=1). Furthermore, when the signal transmission rate and the data reliability are considered at the same level, the same weight may be applied to latency and bit error rate. As a result, a weight (a) for power consumption, a weight (b) for latency, and a weight (c) for bit error rate may be set to 3, 1, and 1, respectively (i.e., a=3, b=1, and c=1).

When the weights are applied to the test results of the respective lanes LANE<0:3>, it may be expressed as the following equation:

Weight-applied value=a*x+b*y+c*z.

Here, x represents a test result for power consumption, y represents a test result for latency and z represents a test result for bit error rate.

FIG. 6 shows a case in which weights of 3, 2, and 1 are applied. The lane rankings may be set with reference to the weight-applied value. According to the result obtained by applying the weights, the lane rankings may be set in order of the third lane LANE3 the first lane LANE1 and the second lane LANE2. When two operating lanes TLANEs are selected, the first and third lanes LANE1 and LANE3 may be selected as the operating lanes TLANEs based on the lane rankings.

In accordance with the embodiments of the invention, a data processing system with multi-channels (or multi-lanes) may communicate through high-ranked channels among the channels, selected based on a test. The high-ranked channels may have a characteristic, which coincides with an operating environment of the data processing system, and thus the performance of the data processing system may increase.

While certain embodiments have been described above, it will be understood to those skilled in the art that the embodiments described are by way of example only. Accordingly, the data processing system described herein should not be limited based on the described embodiments. Rather, the data processing system described herein should only be limited in light of the claims that follow.

What is claimed is:

1. An operating method of a data processing system, comprising:
calculating a test result by performing a test for measuring characteristics of each of lanes included in the data processing system; and
selecting one or more operating lanes among the lanes based on the test result.

2. The operating method of claim 1, wherein the selecting of the one or more operating lanes comprises:
setting lane rankings corresponding to the respective characteristics based on the test result;
determining any one of the characteristics as a lane selection criterion; and
selecting the one or more operating lanes based on the lane rankings corresponding to the lane selection criterion.

3. The operating method of claim 2, wherein the lane selection criterion is determined depending on an operating environment of the data processing system.

4. The operating method of claim 3, wherein the operating environment comprises one or more of power consumption, signal transmission rate, and data reliability of the data processing system.

5. The operating method of claim 1, further comprising:
setting weights to be given on the respective characteristics.

6. The operating method of claim 5, wherein the selecting of the one or more operating lanes comprises:
setting lane rankings by applying the weights to the test result; and
selecting the one or more operating lanes based on the lane rankings.

7. The operating method of claim 6, wherein the weights are set depending on an operating environment of the data processing system.

8. The operating method of claim 6, wherein the operating environment comprises one or more of power consumption, signal transmission rate, and data reliability of the data processing system.

9. The operating method of claim 1, wherein the characteristics include power consumption, latency, and/or bit error rate.

10. A data processing system comprising:
a first device comprising a first control unit;
a second device comprising a second control unit; and
lanes suitable for transmitting signals between the first and second devices,
wherein the first and second control units calculate a test result by performing a test for measuring characteristics of the respective lanes, and select one or more operating lanes among the lanes based on the test result.

11. The data processing system of claim 10, wherein the first and second control units set lane rankings corresponding to the respective characteristics by the test result, determine any one of the characteristics as a lane selection criterion, and select the one or more operating lanes based on the lane rankings corresponding to the lane selection criterion.

12. The data processing system of claim 11, wherein the lane selection criterion is determined depending on an operating environment of the data processing system.

13. The data processing system of claim 12, wherein the operating environment comprises one or more of power consumption, signal transmission rate, and data reliability of the data processing system.

14. The data processing system of claim 10, wherein the first and second control units set weights to be given on the respective characteristics, set lane rankings based on the test result to which the weight is applied, and select the one or more of operating lanes based on the lane rankings.

15. The data processing system of claim 14, wherein the weights are set depending on an operating environment of the data processing system.

16. The data processing system of claim 15, wherein the operating environment comprises one or more of power consumption, signal transmission rate, and data reliability of the data processing system.

17. The data processing system of claim 10, wherein the first device includes a host device, and the second device includes a data storage device.

18. The operating method of claim 10, wherein the characteristics include power consumption, latency, and/or bit error rate.

19. An operating method of a data processing system with multi-channels, the method comprising:
performing a test for measuring a predetermined characteristic of the respective channels;
ranking the channels based on the test result; and
performing a communication through the high-ranked channels selected among the channels.
